(19) United States
(12) Patent Application Publication
(10) Pub. No.: US 2013/0166677 A1
(43) Pub. Date: Jun. 27, 2013

(54) ROLE-BASED ACCESS CONTROL METHOD AND APPARATUS IN DISTRIBUTION SYSTEM

(71) Applicants: Bo-Heung CHUNG, Daejeon (KR); Jeong Nyeo KIM, Daejeon (KR)

(72) Inventors: Bo-Heung CHUNG, Daejeon (KR); Jeong Nyeo KIM, Daejeon (KR)

(73) Assignee: Electronics and Telecommunications Research Institute, Daejeon (KR)

(21) Appl. No.: 13/336,252

(22) Filed: Dec. 23, 2011

(51) Int. Cl. G06F 15/16

(52) U.S. Cl. 709/217

(57) ABSTRACT

A role-based access control apparatus for use in a distribution system including a plurality of nodes, includes a role manager configured to assign the role of a publisher, which processes a request for a data transfer, to a node, and the role of subscribers, which request the data transfer, to remaining nodes, the role relationship between the plurality of nodes being transmitted to the remaining nodes playing the roles of subscribers and the requested data from the remaining nodes being transmitted to the remaining nodes based on the role relationship; and a role monitor configured to manage the role relationship assigned to the plurality of nodes.

### FIELD OF THE INVENTION

The present invention relates generally to a distributed control and, more particularly, to a role-based access control apparatus and method for use in a distribution system, which assigns the roles of a subscriber and a publisher to a plurality of nodes and enables data requests to be processed based on the roles.

### BACKGROUND OF THE INVENTION

Recently, with the realization of high-performance for and the provision of convenient networking functions for Personal Computers (PC), mobile terminals, etc., increasing demands are being made on various types of distribution services using distribution middleware, such as Common Object Request Broker Architecture (CORBA) or Data Distribution Service (DDS). However, in this environment, a simple structure is used in which individual systems are classified into data providers (publishers) and data consumers (subscribers) and in which each publisher publishes the data thereof and each subscriber requests data from a publisher that provides desired information on the basis of the details of the published data to implement a service. However, in this case, there are limitations for the following reasons.

First, it is required a method capable of performing effective access control on data to be shared in distribution middleware having a publisher-subscriber structure. That is, only an authorized user must be able to access the data, and an unauthorized user must be prohibited from accessing the data. However, an existing distribution middleware does not have such a function.

Second, systems operated in this environment generally use different operating systems and access control schemes. In this case, it is very difficult in reality to manage the access control schemes of these systems by linking and integrating the access control schemes. Therefore, there are required methods of, in such an environment, effectively performing access control on shared data between publishers and subscribers at the level of distribution middleware regardless of the operating systems and the access control schemes of the individual systems.

Third, access control methods capable of reducing the real-time characteristics of distribution middleware and a network load must be provided. That is, the data transmission load placed on a data transmission node must be able to be reduced by changing the right to the access control of groups which receive similar data amongst all the nodes which receive pieces of data.

### SUMMARY OF THE INVENTION

In view of the above, the present invention provides a role-based access control apparatus and method for use in a distribution system, which assigns the roles of a subscriber and a publisher to a plurality of nodes and enables data requests to be processed based on the roles.

In accordance with a first aspect of the present invention, there is provided a role-based access control apparatus for use in a distribution system including a plurality of nodes, the apparatus including:

a role manager configured to assign the role of a publisher, which processes a request for a data transfer, to a node, and the role of subscribers, which request the data transfer, to remaining nodes, the role relationship between the plurality of nodes being transmitted to the remaining nodes playing the roles of subscribers and the requested data from the remaining nodes being transmitted to the remaining nodes based on the role relationship; and

a role monitor configured to manage the role relationship assigned to the plurality of nodes.

In accordance with a second aspect of the present invention, there is provided a role-based access control apparatus for use in a distribution system including a plurality of nodes, the apparatus including:

a role checking unit configured to receive role information, in which a role relationship with a node playing the role of publisher that processes a request for data transfer has been established, when receiving data from the node playing the role of publisher among the plurality of nodes, and communicate with the node playing the role of publisher based on the role information.

In accordance with a third aspect of the present invention, there is provided a role-based access control method in a distribution system including a plurality of nodes, the method including:

establishing a role relationship by assigning the role of a publisher, which processes the request for data transfer, to a node, and the role of subscribers, which request the data transfer, to remaining nodes;

publishing data managed by the node playing the role of publisher to the nodes established to the subscribers; and

transmitting data corresponding to the data transfer request to the nodes which made the data transfer request.

### BRIEF DESCRIPTION OF THE DRAWINGS

The above and other objects and features of the present invention will become apparent from the following description of preferred embodiments given in conjunction with the accompanying drawings, in which:

FIG. 1 is a diagram illustrating a procedure for sharing or transferring distributed data in a distribution system in accordance with a related art;

FIG. 2 is a block diagram showing the detailed construction of a role-based access control apparatus in accordance with an embodiment of the present invention;

FIG. 3 is a diagram of a distribution system including the role-based access control apparatus in accordance with an embodiment of the present invention;

FIG. 4 is a diagram showing the role escalation of a node performed by the role-based access control apparatus in accordance with an embodiment of the present invention;

FIG. 5 is a flowchart showing the role escalation procedure of FIG. 4;

FIGS. 6 and 7 are diagrams showing a role de-escalation procedure performed by the role-based access control apparatus due to a new data request which is additionally generated in accordance with an embodiment of the present invention; and

FIG. 8 is a flowchart showing the role de-escalation procedure of FIGS. 6 and 7.

### DETAILED DESCRIPTION OF THE PREFERRED EMBODIMENTS

Hereinafter, embodiments of the present invention will be described in detail with reference to the accompanying drawings so that they can be readily implemented by those skilled in the art.

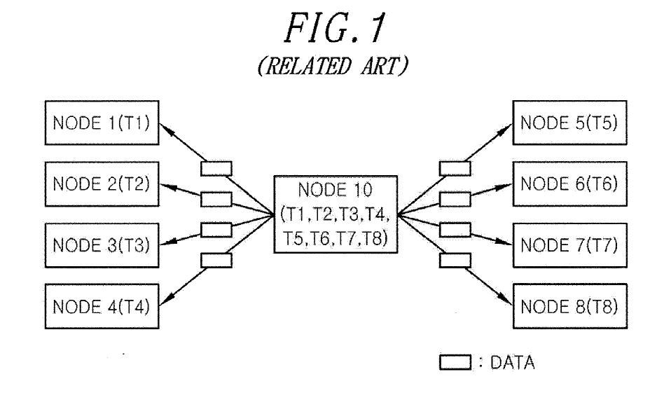

FIG. 1 is a diagram illustrating a procedure for sharing or transferring distributed data in a distribution system in accordance with a related art.

In FIG. 1, individual distributed systems are indicated by nodes 1, 2, 3, 4, 5, 6, 7, 8, and 10, and the nodes 1 to 8 among the nodes request access to pieces of data T1 to T8 that are present in the node 10.

In the case of FIG. 1, the node 10 is generally designated as a data provider referred to as a publisher, the nodes 1 to 8 are generally designated as data consumers referred to as subscribers, and pieces of data T1 to T8 are designated as pieces of requested data referred to as topics. That is, the node 10 publishes data desired to be shared to the outside of the node 10 via a role-based access control apparatus of the present invention, and the nodes 1 to 8 send a data transfer request or data sharing request for their desired data to the node 10 on the basis of the published data. And then, the desired data is continuously transferred from the node 10 to the individual nodes 1 to 8.

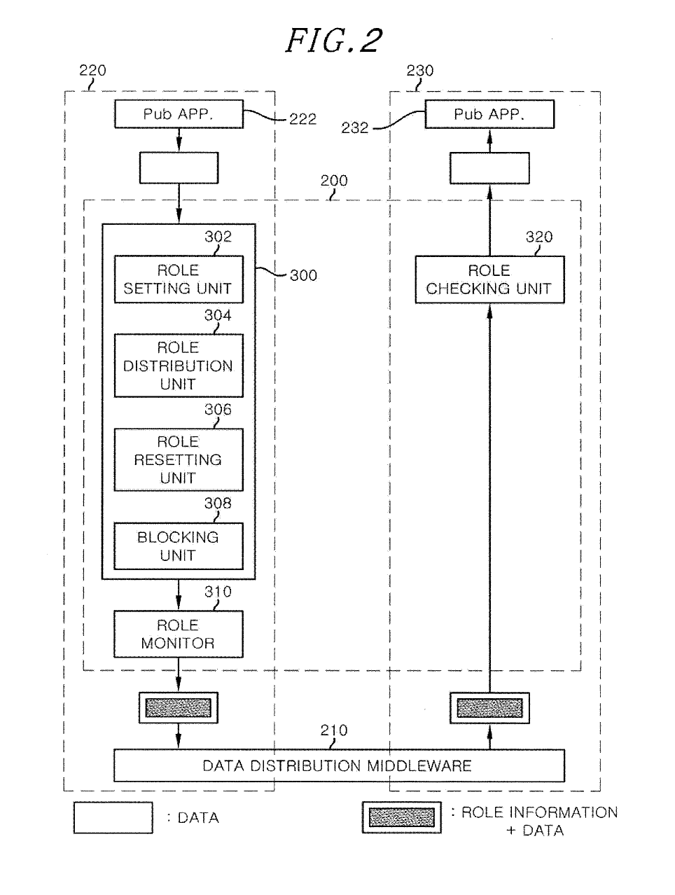

FIG. 2 is a block diagram showing the detailed construction of a role-based access control apparatus in accordance with an embodiment of the present invention.

As shown in FIG. 2, the distribution system includes a plurality of physically separated host systems, for example, nodes 220 and 230, a data distribution middleware 210 for connecting the nodes 220 and 230, and a role-based access control apparatus 200.

The data distribution middleware 210 serves to transfer data between the nodes 220 and 230.

Among nodes 220 and 230, the node 220 plays the role of a publisher (hereinafter referred to as a “Pub”), and the node 230 plays the role of a subscriber (referred to as a “Sub”). Data is transferred from an application program 222 of the node 220 to an application program 232 of the node 230 via the data distribution middleware 210. The role-based access control apparatus 200 is installed in the distribution system in the form of a secure middleware, and includes a role manager 300, a role monitor 310 and a role checker 320. The role-based access control apparatus 200 of the secure middleware participates in a security processing procedure based on roles.

The role manager 300 and the role monitor 310 may be joined in the node 220 and the role checker 320 may be joined in the node 230, or vice versa.

The role manager 300 assigns the role of a publisher (Pub role) and the role of a subscriber (Sub role) to the node 220 and 230, respectively. In this case, the role relationship between the nodes 220 and 230 may be including pieces of information such as role information, host information, application program information, location information, and period information. The node 220 playing the role of a publisher is managed by the role monitor 310 and shares the role monitor 310 with the node 230 playing the role of a subscriber.

After assigning the roles, the role relationship between the nodes 220 and 230 is inspected by the data distribution middleware 210 upon data transmission, so that data is transferred only to the node 230 having the justifiable rights to do so. In this case, the maintenance of encryption or security of transmission channels may be generally implemented using schemes that have been used most widely, for example, a Virtual Private Network (VPN), Internet Protocol Security (IPSec), Advanced Encryption Standard (AES), or Message Digest 5 (MD5).

The role monitor 310 performs to manage, store and monitor information about roles assigned in this way. When a task of escalating or de-escalating the assigned roles is required by the analysis of nodes having the role of subscribers connected to the publisher, the role monitor 310 changes the role relationship, and then requests the role manager 300 to update the changed roles. In response thereto, the role manager 300 performs the task of escalating or de-escalating roles for the nodes.

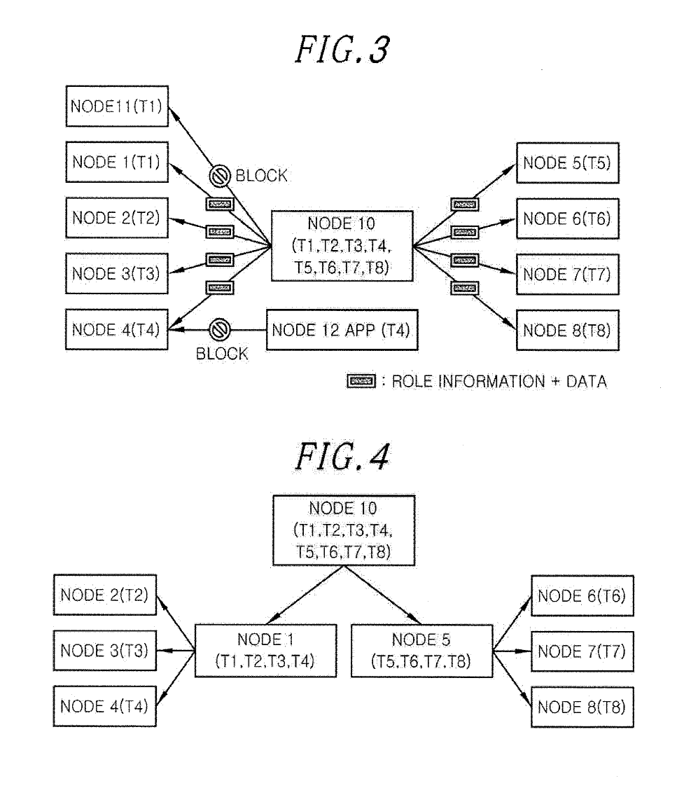

The role manager 300 includes a role setting unit 302, a role distribution unit 304, a role resetting unit 306, and a blocking unit 308, the operation of which will be explained with reference to FIG. 3.

FIG. 3 is a diagram of a distribution system including the role-based access control apparatus in accordance with an embodiment of the present invention.

Referring to FIG. 2, the distribution system includes a plurality of nodes 1, 2, 3, 4, 5, 6, 7, 8, and 10 which play the role of any one of data providers (publishers) and data consumers (subscribers), and nodes 11 and 12 which are fake nodes.

As described above, the role-based access control apparatus 200 is installed in the nodes in the form of the secure middle ware. Among a plurality of nodes 1, 2, 3, 4, 5, 6, 7, 8, and 10, the role of a Sub is assigned to nodes 1 to 8, the role of a Pub is assigned to the node 10. Reference numerals 11 and 12 represent fake nodes. In accordance with the present invention, only communication between the nodes, the role relationship of which has been established, is allowed, thus preventing illegal access made by the fake nodes 11 and 12 from occurring.

The role setting unit 302 sets the role of any one of the nodes 1, 2, 3, 4, 5, 6, 7, 8, and 10, for example, the node 10, to the role of a Pub, and sets the role of the remaining nodes 1, 2, 3, 4, 5, 6, 7, and 8 to the role of a Sub, thereby establishing a role relationship between nodes 1, 2, 3, 4, 5, 6, 7, 8, and node 10. During the procedure of establishing the role relationship, an authentication procedure is performed between the node set to the Pub and the remaining nodes.

Thereafter, when data is transmitted from the node 10 playing the Pub role to the remaining nodes 1, 2, 3, 4, 5, 6, 7, and 8 playing the Sub role via the distribution middleware 210, role information as well as the data is also included and then transmitted. In this case, pieces of data that are transmitted may be sent after an encrypted channel or a secure channel has been set up.

The role distribution unit 304 escalates the role of the nodes set to the Sub in response to a request based on monitoring by the role monitor 310. In other words, the role monitor 310 analyzes the role relationship between the nodes 1, 2, 3, 4, 5, 6, 7, and 8 set to the Sub, manages nodes that request similar data as a group, and transfers a request for reestablishing a role relationship between the nodes within the group to the role manager 300. In response to the request for reestablishing a role relationship, the role distribution unit 304 sets any one of the nodes within the group to a Publisher-Subscriber (hereinafter referred to as a Pub-Sub), and provides via communication between the remaining nodes within the group and the node set to the Pub-Sub. In this case, the role distribution unit 304 releases the role relationship between node 10 set to the Pub and the node set to the Pub-Sub, thus enabling the load on node 10 to be dispersed.

Meanwhile, the node set to the Pub-Sub within the group receives data from node 10, and then process data requests from the remaining nodes within the group by using the received data.

When a data request is newly received from certain nodes of the nodes 1, 2, 3, 4, 5, 6, 7, and 8 that have been set to Sub nodes after the establishment of the role relationship, the role resetting unit 306 releases the role relationship that has been established between the certain nodes which request the new data and the node 10, and reestablishes the role relationship between the certain nodes and the node 10.

In addition, when a node set to a Pub-Sub is included in the certain nodes, the role relationship of which has been reestablished, the role resetting unit 306 changes the role of the node set to the Pub-Sub to the role of a Sub.

A role checking unit 320 installed in a node set to the Sub receives role information, in which a role relationship with a node set to a Pub has been established, when receiving data from the Pub node, and requests data by communicating with the Pub node on the basis of the role information.

As described above, in accordance with the role-based access control apparatus 200, the role relationship between the node 10 and the remaining nodes 1, 2, 3, 4, 5, 6, 7, and 8 is achieved using the authentication procedure. Further, the role information as well as data is transmitted via an encrypted channel or a secure channel in response to the data requests. As a result, the present invention can effectively prevent the occurrence of the case where a subscriber application program is faked by the fake nodes 11 and 12, or the case where a publisher application program is faked by the fake nodes 11 and 12. In other words, since the transmission of data is possible only between node 10 and the remaining nodes 1, 2, 3, 4, 5, 6, 7, and 8, the role relationship of which has been previously established by node 10 playing the role of the Pub, the behavior of the fake nodes 11 and 12 can be effectively blocked.

Following is a description of a procedure in which the role-based access control apparatus 200 escalates the role of any information-requesting node in accordance with an embodiment of the present invention, which will be made with reference to FIG. 4.

FIG. 4 is a diagram showing the role escalation of a certain node performed by the role-based access control apparatus in accordance with an embodiment of the present invention.

In the case where a role relationship between a Pub and a Sub is established as shown in FIG. 3, concentration of traffic on the node 10 which plays the role of the Pub may occur, and then a load on the node 10 may increase. In order to solve this problem, as shown in FIG. 4, the role-based access control apparatus 200, which is installed in the node 10 as described above, analyzes the role relationship between the node 10 and the nodes 1, 2, 3, 4, 5, 6, 7, and 8, and manages nodes which request similar information as a group. Further, the role-based access control apparatus 200 allows any one node within the group to escalate to the role of a Pub. For example, since the nodes 1, 2, 3 and 4 are provided with topics T1, T2, T3, and T4 by the node 10, the role of a certain node, e.g., node 1, among those nodes may be reestablished to the role of a Pub within the group, so that the role of a Pub-Sub may be assigned to the node 1. Thereafter, the node 1 may request for data T2, T3 and T4 from the node 10, and receive the requested data from the node 10. In this case, the nodes 2, 3, and 4 form a Pub-Sub relationship with the node 1, and release a previous Pub-Sub relationship with the node 10. By this procedure, traffic and a load that may be concentrated on the node 10 playing the role of the Pub can be effectively distributed.

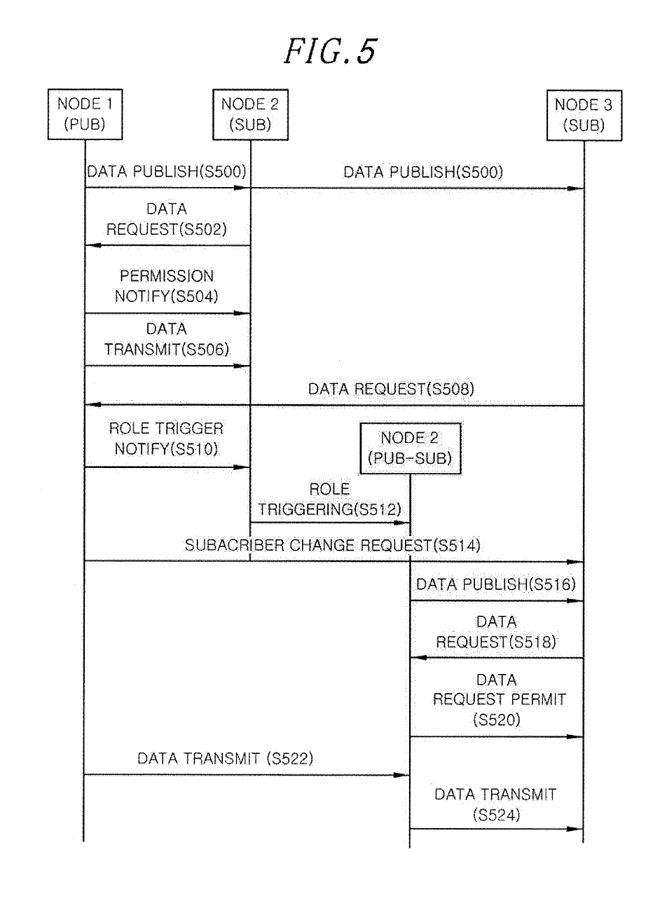

A procedure in which the role-based access control apparatus 200 performs role escalation in conjunction with nodes as set forth above will be described with reference to FIG. 5.

FIG. 5 is a flowchart showing the individual steps of the role escalation procedure.

Prior to the description of FIG. 5, it is assumed that node 1 is designated to play the role of a Publisher (Pub) and nodes 2 and 3 are designated to play the role of Subscribers (Sub).

At step S500, the node 1 publishes data that it can currently provide to the others.

Next, the node 2 makes a request of data transfer for the data published by the node 1 at step S502.

Thereafter, the node 1 notifies the node 2 that the data transfer request has been permitted at step S504, and the node 1 then transmits the requested data to the node 2 at step S506.

When the node 3 newly requests data transfer from the node 1 at step S508, the node 1 analyzes a role relationship for the new data transfer request, determines to escalate the role of the node 2, and changes the role of the node 2 from a Sub to a Pub-Sub based on the determined role escalation at step S510. In other words, the node 1 sends notification of a role trigger to the node 2, which notifies the node 2 that the role of the node 2 has changed from a Sub to a Pub-Sub. Accordingly, the node 2 can be assigned to the role of a Pub-Sub via role triggering at step S512.

Further, in response to the data transfer request of the node 3, the node 1 sends a subscribe change request inducing the node 3 to request the data transfer from a new node, that is, the node 2, to the node 3 at step S514.

Meanwhile, the node 2, the role of which has been escalated to the role of a Pub-Sub, publishes data that it can provide to the outside via a data publish procedure at step S516.

Thereafter, the node 3 issues to the node 2 a subscriber request message requesting a data transfer from the node 2 at step S518. The node 2 notifies the node 3 of a subscriber OK message, and then permits the data transfer request at step S520.

Thereafter, the node 2 transmits the data received from the node 1 to the node 3 via the node 2 at sequential steps S522 and S524.

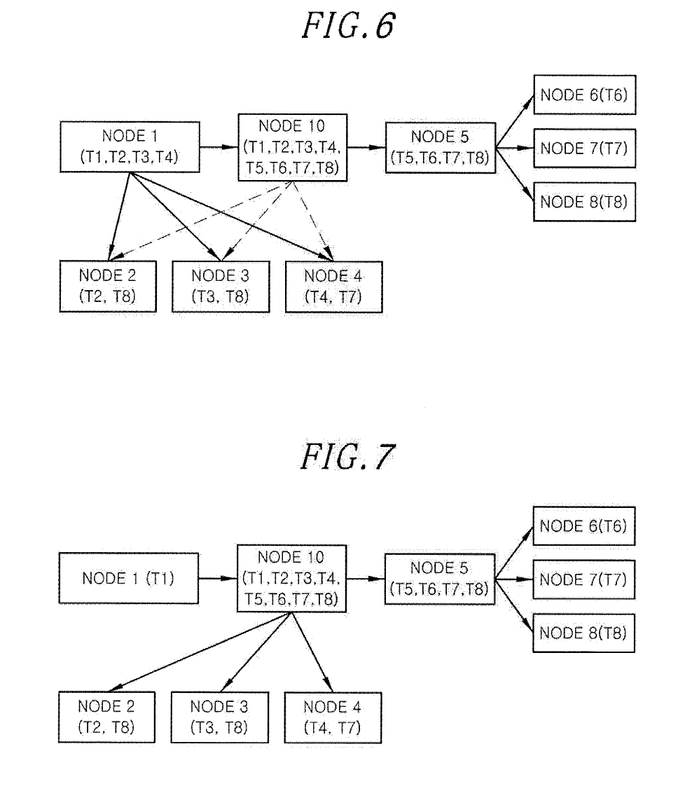

Following is a description of a procedure in which a role is de-escalated due to a new data request additionally made by a certain node, which will be made with reference to FIGS. 6 and 7.

FIGS. 6 and 7 are diagrams showing a role de-escalation procedure performed by the role-based access control apparatus due to a new data request or the like that is additionally generated in accordance with an embodiment of the present invention.

When a new data request is generated after the role relationship has been established, as shown in FIG. 4, there is a need to change an existing role relationship. This change of the role relationship may be performed by the role resetting unit 306 of the role-based access control apparatus 200.

For example, as shown in FIG. 6, when the node 2 requests data T8, the node 3 requests data T8, and the node 4 also requests data T7, the node 10 playing the role of a Pub analyzes the new data requests. By analysis, the node 1 may not need to transmit pieces of data requested by the nodes 2, 3, and 4. In this case, since the node 1 does not require the role of a Pub while playing the role of a Pub-Sub, the node 1 has changed to play the role of a Sub as before. The results of the change of the role relationship are shown in FIG. 7. That is, the role of the node 1 is changed to the role of the Sub of the node 10 from the role of a Pub-Sub, and the roles of the node 2, 3, and 4 are changed to the role of the Sub of the node 10.

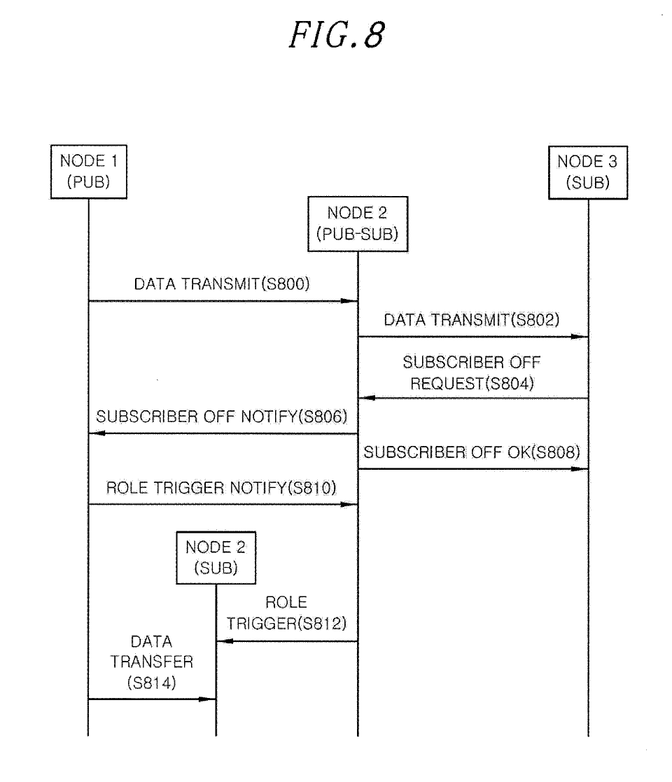

A procedure in which the role-based access control apparatus 200 performs role de-escalation in conjunction with the nodes as set forth above will be described in detail with reference to FIG. 8.

FIG. 8 is a flowchart showing the role de-escalation procedure of FIGS. 6 and 7.

Prior to the description of the role de-escalation procedure, it is assumed that node 1 is designated to play the role of a Publisher (Pub), node 2 is designated to play the role of Publisher-Subscribers (Pub-Sub), and node 3 is designated to play the role of Subscribers (Sub), as described above with reference to FIG. 5.

As shown in FIG. 8, data requested by the node 3 is transmitted from the node 1 to the node 2 at step 5800 and then from the node 2 to the node 3 at step 5802.

Thereafter, in order for the node 3 not to receive any further data from the node 2, the node 3 sends a subscriber off request message, that is, a message required to stop the role of a Sub, to the node 2 at step S804.

Then, after the node 2 transfers this request to the node 1 as a subscriber off notify message at step S806, the node 2 sends a subscriber off OK message to the node 3 in response to the subscriber off request at step S808. Accordingly, the node 1 recognizes that the node 2 does not need to play the role of a Pub-Sub by analyzing a role relationship, and sends a role trigger notify message to the node 2 so that the node 2 plays only the role of a Sub at step S810.

Thereafter, role de-escalation from the role of a Pub-Sub to the role of a Sub occurs on the node 2 via role triggering at step S812. Accordingly, the node 2 receives data from the node 1 as the role of a Sub at step S814.

As described above, the role-based access control apparatus and method may be operated based on software, and tasks such as the management and inspection of role information are developed and provided in the form of a plug-in module, and thus can easily work in conjunction with the existing distribution middleware.

Further, the role-based access control apparatus and method can also be easily applied in the form of hardware, and therefore, may be developed in the form of hardware such as the form of a Trusted Platform Module (TPM) or a security Universal Serial Bus (USB).

In accordance with the present invention, access to sensitive information is managed at the level of distribution secure middleware, so that access to the sensitive information can be definitely recognized at the level of distribution secure middleware, and illegal access attributable to malicious hacking tools which deviate from previously set policies for the management of important information can be effectively prevented.

Further, since the present invention is managed at the level of distribution secure middleware, it is easy to manage sensitive information in a distributed environment without resulting in additional costs and confusion which inevitably result from the integration and interaction of individual access control techniques for the variety of systems present in a distributed environment.

While the invention has been shown and described with respect to the particular embodiments, it will be understood by those skilled in the art that various changes and modification may be made without departing from the scope of the present invention as defined in the following claims.

What is claimed is:

1. A role-based access control apparatus for use in a distribution system including a plurality of nodes, the apparatus comprising:
a role manager configured to assign the role of a publisher, which processes a request for a data transfer, to a node, and the role of subscribers, which request the data transfer, to remaining nodes, the role relationship between the plurality of nodes being transmitted to the remaining nodes playing the roles of subscribers and the requested data from the remaining nodes being transmitted to the remaining nodes based on the role relationship; and
a role monitor configured to manage the role relationship assigned to the plurality of nodes.

2. The role-based access control apparatus of claim 1, wherein the role monitor is further configured to analyze the role relationship assigned to the remaining nodes playing the roles of subscribers, manages nodes, which request similar data transfer, as a group, and transfer a request for reestablishing a role relationship between the nodes within the group to the role manager; and
wherein the role manager comprises a role distribution unit configured to establish any one of nodes within the group to a role of publisher-subscriber, change a relationship between the node established to the publisher-subscriber and remaining nodes within the group to a publisher-subscriber relationship, and release a role relationship between the remaining nodes within the group and the node established to the role of publisher.

3. The role-based access control apparatus of claim 1, wherein transmission of data between the node playing the role of publisher and the nodes playing the role of subscriber is performed via an encrypted channel.

4. The role-based access control apparatus of claim 1, wherein the role manager comprises a role resetting unit configured to, when a request of a data transfer is newly received from one or more of the nodes established to the role of subscriber, reestablishing a role relationship between the node playing the role of publisher and the nodes which made the new data transfer request.

5. The role-based access control apparatus of claim 4, wherein the role monitor is further configured to analyze the role relationship for the nodes, which has requested the data transfer, manages nodes, which request similar data transfer, as a group, and transfer a request for reestablishing a role relationship between the nodes within the group to the role manager;
wherein the role manager comprises a role distribution unit configured to set any one of nodes within the group to a role of publisher-subscriber, change a role relationship between the node playing the role of publisher-subscriber and remaining nodes within the group to a publisher-subscriber relationship, and release a role relationship between the remaining nodes within the group and the node playing the role of publisher; and
wherein the role resetting unit is further configured to change a role of the node established to the role of the publisher-subscriber to a subscriber when the node established to the role of publisher-subscriber is included in the nodes, the role relationship of which has been reestablished.

6. The role-based access control apparatus of claim 1, wherein the role relationship is accomplished by a procedure for authentication between the nodes.

7. The role-based access control apparatus of claim 1, wherein the role manager comprises a blocking unit configured to block a request of a data transfer from a node, the role relationship of which has not been established.

8. A role-based access control apparatus for use in a distribution system including a plurality of nodes, the apparatus comprising:
a role checking unit configured to receive role information, in which a role relationship with a node playing the role of publisher that processes a request for data transfer has been established, when receiving data from the node playing the role of publisher among the plurality of nodes, and communicate with the node playing the role of publisher based on the role information.

9. A role-based access control method in a distribution system including a plurality of nodes, comprising:
establishing a role relationship by assigning the role of a publisher, which processes the request for data transfer, to a node, and the role of subscribers, which request the data transfer, to remaining nodes;
publishing data managed by the node playing the role of publisher to the nodes established to the subscribers; and
transmitting data corresponding to the data transfer request to the nodes which made the data transfer request.

10. The role-based access control method of claim 9, further comprising:
grouping the nodes playing the role of subscribers;
changing a role of any one of the nodes playing the role of subscribers within a group to a role of a publisher-subscriber, and establishing a publisher-subscriber relationship between the node playing the role of publisher-subscriber and remaining nodes within the group; and
releasing a role relationship between the remaining nodes within the group and the node playing the role of publisher.

11. The role-based access control method of claim 10, further comprising:
when a new data transfer request or an data transfer request off request is received from the remaining nodes within the group, changing a role of the node established to the publisher-subscriber, to a role of a subscriber of the node playing the role of publisher.

12. The role-based access control method of claim 9, wherein said grouping the nodes playing the role of subscribers includes grouping nodes, which request similar data transfer among the nodes established to the subscribers.
